(19) United States
(12) Patent Application Publication
(10) Pub. No.: US 2007/0237388 A1
(43) Pub. Date: Oct. 11, 2007

(54) Classification system

(76) Inventors: James Mahon, Dublin (IE); Brian MacNamee, Dublin (IE); Richard Evans, Dublin (IE); John Doherty, Dublin (IE)

Correspondence Address: PERMAN & GREEN, 425 POST ROAD, FAIRFIELD, CT, 06824, US

(21) Appl. No.: 11/405,145

(22) Filed: Apr. 17, 2006

(30) Foreign Application Priority Data
May 6, 2005 (GB) 0509265.5

(51) Int. Cl. G06K 9/62

(52) U.S. Cl. 382/159

(57) ABSTRACT

A classification system or classifying images of solder joints has a two-sided classifier to which query cases are presented. It can operate in an environment without task-specific counter-concept cases (“bad examples”) because it filters a library of general counter-concept cases to provide a refined set of counter-concept cases. The filtering is performed by a one-sided classifier, which uses a base of task-specific concept cases to perform the filtration.

### INTRODUCTION

The invention relates to classification systems and to machine vision systems incorporating them.

In a typical scenario a binary classifier is trained to distinguish between a concept class and a counter-concept class. Training involves presenting to a classifier a set of examples for which the correct classifications are known, and adjusting the internal parameters of the classifier based on its ability to correctly classify these training examples. When both concept and counter-concept examples are used during training a classifier is said to be two-sided, and classification accuracy is typically high.

However, in some cases counter-concept training examples are unavailable or expensive to obtain, and so classifiers must be trained in their absence. One example of this is a classifier used as part of a machine vision system for inspection of solder joints—i.e. to distinguish between acceptable and defective joints. At training time, although examples of acceptable joints are usually plentiful, examples of defective joints are rarely available.

In the situation where counter-concept examples are unavailable for training, one approach is to use a single-sided classifier, which is trained to recognize a concept class, rather than distinguish between concept and counter-concept classes. Unfortunately, single-sided classifiers only match the accuracies of two-sided classifiers under very specific, and rare, conditions. Furthermore, it has been seen empirically that single-sided classifiers can require larger amounts of concept training data than two-sided classifiers, which can add significantly to training time.

This invention addresses the problem of building classifiers for inspection systems in the absence of specific counter-concept examples.

### SUMMARY OF INVENTION

According to the invention, there is provided a classification system comprising a two-sided classifier for using concept cases and counter-concept cases to classify query cases, wherein the system further comprises:
a filter for filtering a library of counter-concept cases to provide a refined counter-concept case-base for use by the two-sided classifier for a particular classification session.

In one embodiment, the filter comprises a single-sided classifier.

In another embodiment, the filter uses a task-specific concept case-base to filter the library of counter-concept cases.

In a further embodiment, the filter operates by comparing a library case with a plurality of concept cases.

In one embodiment, a score is determined for said comparison, and a threshold is automatically generated, and one side of the threshold indicates a concept case and the other indicates a counter-concept case.

In another embodiment, the system comprises a feedback mechanism for dynamically updating the task-specific concept case-base upon identification of false failures during classification.

In a further embodiment, the system comprises a feedback mechanism for dynamically updating the filtered counter-concept case-base upon identification of genuine failures during classification.

In one embodiment, said feedback mechanism updates the library of counter-concept cases.

In another embodiment, further comprises means for generating the library of counter-concept cases.

According to another aspect, the invention provides a machine vision system comprising a classification system as defined above.

In one embodiment, the machine vision system is a solder paste inspection system.

### DETAILED DESCRIPTION OF THE INVENTION

The invention will be more clearly understood from the following description of some embodiments thereof, given by way of example only with reference to the accompanying drawings in which:

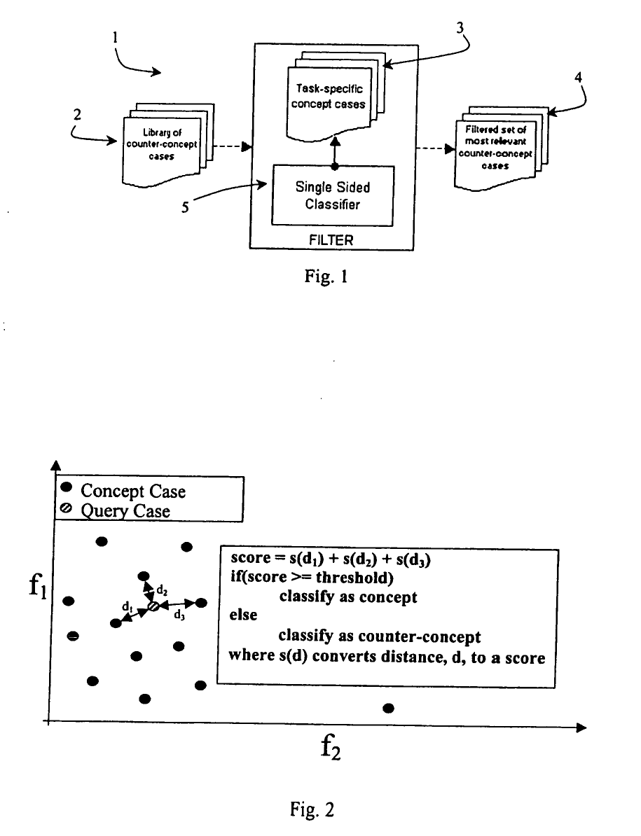

FIG. 1 is a flow diagram of a filter process used as part of the invention;

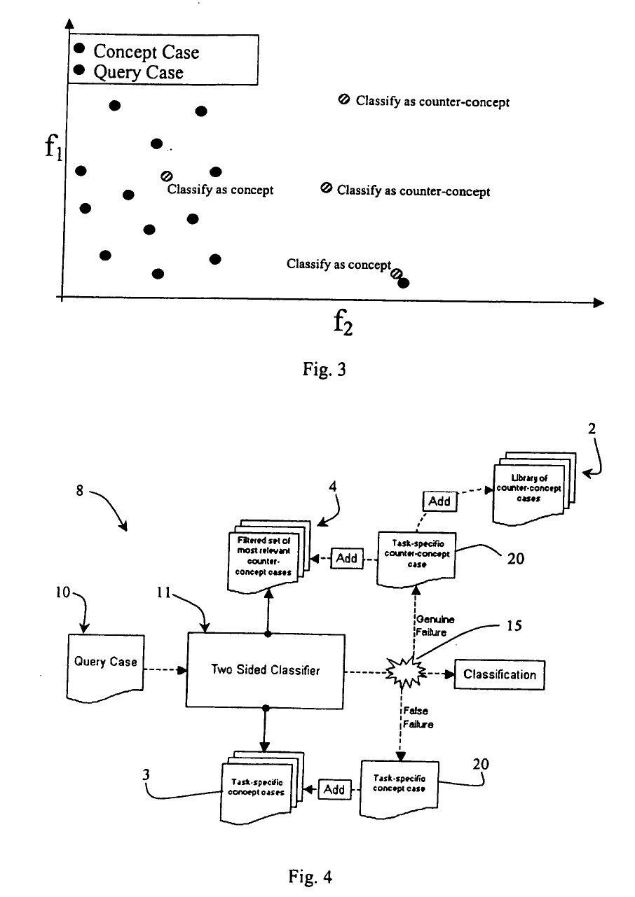

FIGS. 2 and 3 are plots showing operation of the filter process; and

FIG. 4 is a flow diagram showing classification processing by the system.

The invention provides an effective classifier for a machine vision system when only concept examples for the specific inspection task are at hand. It uses a library of counter-concept examples from somewhat similar tasks.

In general, it is highly likely that counter-concept examples will be found by an inspection system during its operation. Since many inspection tasks require that classifiers are created repeatedly for similar classes of problems, it is reasonable to suggest that in these cases a sizeable library of similar counter-concept examples could be collected. For example, for the inspection of solder joints, separate classifiers might be built for each joint type, on each model of board manufactured. All of the joints flagged by these disparate systems as being defective could be collected into a library of defective joint examples.

Referring to FIG. 1 a filter process 1 enables a subset of such a library of previously collected counter-concept examples 2, which are most relevant to a set of task-specific concept examples 3, to be selected.

The library of counter-concept examples 2 is collected from classifiers built for similar inspection tasks. These classifiers periodically classify query cases as being members of the counter-concept class. After a verification (either automatically or by a human operator), these query cases can be added to the library of counter-concept cases. The inspection of solder joints serves as an illustrative example of this. Individual classifiers are typically built for each type of joint on each type of board to be inspected. Whenever a joint is classified as being defective, this is verified by a human operator. If the joint is truly defective it can be added to the library of counter-concept cases as a real example of a defective solder joint.

Also, a case-base 3 of task-specific concept cases is provided. Typically, such a set (“good” samples) are readily available.

However, because the members of the library of counter-concept cases 2 come from many disparate sources, many of its cases will not be suitable for each specific classification situation. This problem is overcome by executing the filter process 1 to provide a case-base 4 of those members of the library of counter-concept cases 2 that are most relevant to the inspection task at hand, which is characterised by the set of task-specific concept cases 3. The filtering is performed by a single-sided classifier 5, which makes use of the case-base 3 of task-specific concept cases to identify the most applicable cases of the library of counter-concept cases 2.

The single-sided classifier 5 is particularly effective at identifying and removing those members of the library of counter-concept cases 2 which are in the same domain as the task-specific concept cases 3. Therefore, at the subsequent classification, noise input is comprehensively reduced.

When a query case is presented for classification, it is compared to all cases present in a case-base made up exclusively of concept cases. The distance from the query case to each member of the case-base is calculated and the distances to those cases which are closest to the query case are summed and converted to a score. The score is calculated in such a way that query cases which are closer to members of the case-base are given higher scores than those that are further away. If the calculated score is higher than an automatically determined threshold, then the query case is considered a member of the concept class, otherwise it is considered a member of the counter-concept class.

Referring to FIG. 2, the concept cases (each composed of two features) used by a single sided classifier and one query case are shown. The classification process is illustrated. Referring to FIG. 3, classifications of some other query cases are shown.

Referring to FIG. 4, classification system 8 operates by a query case 10 being presented to a two-sided classifier 11. The classifier 11 can operate in the typical two-sided manner with good performance because it uses both concept cases (the case-base 3 of task-specific concept cases) and counter-concept cases (the filtered case-base 4 generated by the filter process 1).

The output of the two-sided classifier 11 is monitored (either automatically or by a human operator) to identify genuine failures and false failures. The genuine failure cases 20 are automatically added to the filtered set 4 for real time feedback for this situation, and to the library of counter-concept cases 2 for use in the creation of future classifiers. The false failure cases 25 are added to the set 3 of task specific concept cases.

The invention is not limited to the embodiments described but may be varied in construction and detail.

1. A classification system comprising a two-sided classifier for using concept cases and counter-concept cases to classify query cases, wherein the system further comprises:
a filter for filtering a library of counter-concept cases to provide a refined counter-concept case-base for use by the two-sided classifier for a particular classification session.

2. A classification system as claimed in claim 1, wherein the filter comprises a single-sided classifier.

3. A classification system as claimed in claim 1, wherein the filter uses a task-specific concept case-base to filter the library of counter-concept cases.

4. A classification system as claimed in claim 1, wherein the filter operates by comparing a library case with a plurality of concept cases.

5. A classification system as claimed in claim 4, wherein a score is determined for said comparison, and a threshold is automatically generated, and one side of the threshold indicates a concept case and the other indicates a counter-concept case.

6. A classification system as claimed in claim 3, wherein the system comprises a feedback mechanism for dynamically updating the task-specific concept case-base upon identification of false failures during classification.

7. A classification system as claimed in claim 1, wherein the system comprises a feedback mechanism for dynamically updating the filtered counter-concept case-base upon identification of genuine failures during classification.

8. A classification system as claimed in claim 7, wherein said feedback mechanism updates the library of counter-concept cases.

9. A classification system as claimed in claim 1, further comprising means for generating the library of counter-concept cases.

10. A machine vision system comprising a classification system of claim 1.

11. A machine vision system as claimed in claim 10, wherein the machine vision system is a solder paste inspection system.
